(19) United States
(12) Patent Application Publication
(10) Pub. No.: US 2009/0193915 A1
(43) Pub. Date: Aug. 6, 2009

(54) SEPARABLE BALL SCREW

(76) Inventor: Feng-Ho WANG, Hsinchu (TW)

Correspondence Address: Feng-Ho WANG, 235 Chung - Ho, Box 8-24, Taipei, TW

(21) Appl. No.: 12/024,115

(22) Filed: Feb. 1, 2008

(51) Int. Cl. F16H 3/08

(52) U.S. Cl. 74/89.23

(57) ABSTRACT

A separable ball screw comprises a screw shaft having a helical groove; a transfer ring, a plurality of balls and a separable nut being sequentially engaged to the screw shaft; the balls being distributed in the holes in the annular surface of the transfer ring; the transfer ring being hollowed, the retaining ring enclosing around the screw shaft; the plurality of holes being formed in the annular surface; the balls being received in the holes; the balls being received in the holes of the transfer ring as power transfer medium between the transfer ring and the screw shaft; and a separable nut having a hollow center; the separable nut enclosing around the transfer ring; an inner annular surface of the separable nut having at least one grooves; the inner annular surface and the groove serving for limiting positions of the balls.

### FIELD OF THE INVENTION

The present invention relates to ball screws, and particularly to a separable ball screw, which has both functions of helical movement and linear movement so as to match different movement mechanism. A separable nut is used to control the positions of the balls. By the indirect contact of the screw shaft and the separable nut, the application of the ball screw is promoted, which is especially suitable for rapid reciprocal and traveling limited ball screw.

### BACKGROUND OF THE INVENTION

The ball screw has the advantages of low friction coefficient, high efficiency, and high precision. In industry, a predetermined number of balls are arranged in the helical groove between the screw shaft and the sleeve of the screw shaft. By rotating the screw shaft, the sleeve will move reciprocally along the screw shaft. However for a long time, the balls will wear so that a great error generates, even the wearing of the groove will make the screw shaft shift, bend or break.

In Taiwan Patent No. TW266376Y, “Improved structure of nut circulation structure for ball screw”, at least one ball circling groove is formed at an outer side of a screw shaft. A plurality of balls roll between the helical grooves of the screw shaft and the nut unit. The balls are guided to a tube inlet and then to a helical groove between the screw shaft and the helical groove of the nut so as to form a cyclic path.

Furthermore, in another Taiwan Patent No. TW259875B, “Ball screw for high load and with limited travel”, in that a ball screw has a screw shaft, an outer seat, a ball sleeve, and a limit element. A shaft body of the screw shaft is formed with a helical groove. The feature is that the sleeve is installed between the screw shaft and the seat and then the limiting element is positioned by a fixing cover. A post of the limiting element passes through a positioning hole of the sleeve so that the limiting element will control the positioning and interface of the sleeve and the helical groove so as to calibrate the errors in the reciprocal movement of the sleeve and thus the lifetime of the ball screw is prolonged.

However the prior art features have some defects, such as the structure is more complicated and the reciprocal movement speed is low. Moreover, the ball screw is not economic to a small size electronic device. Therefore, it is desired to have a structure which can move helically or linearly by the coupling between a separable nut and a screw shaft so as to promote the application of the ball screw, which is especially suitable for a rapidly reciprocal ball screw.

### SUMMARY OF THE INVENTION

Accordingly, the primary object of the present invention is to provide a separable ball screw, which has both functions of helical movement and linear movement so as to match different movement mechanism. A separable nut is used to control the positions of the balls. By the indirect contact of the screw shaft and the separable nut, the application of the ball screw is promoted, which is especially suitable for rapid reciprocal and traveling

To achieve above objects, the present invention provides a separable ball screw, comprising:

a screw shaft having a helical groove; a transfer ring, a plurality of balls and a separable nut being sequentially engaged to the screw shaft; the balls being distributed in the holes in the annular surface of the transfer ring;

the transfer ring being hollowed, the retaining ring enclosing around the screw shaft; the plurality of holes being formed in the annular surface; the balls being received in the holes;

the balls being received in the holes of the transfer ring as power transfer medium between the transfer ring and the screw shaft; and

a separable nut having a hollow center; the separable nut enclosing around the transfer ring; an inner annular surface of the separable nut having at least one grooves; the inner annular surface and the groove serving for limiting positions of the balls; when the balls in the grooves, the screw shaft being not engaged to the transfer ring; the screw shaft moves linearly, when the balls being limited by the inner annular surface, it is driven as the ball screw.

By above components, the separable nut serves to limit the positions of the balls so as to control the coupling between the transfer ring and the screw shaft to promote the application of the ball screw, and particularly to a rapid reciprocal and traveling limit ball screws.

The various objects and advantages of the present invention will be more readily understood from the following detailed description when read in conjunction with the appended drawing.

### BRIEF DESCRIPTION OF THE DRAWINGS

FIG. 1 is a perspective view of the ball screw of the present invention.

FIG. 2 is an explosive schematic view showing the components of the ball screw of the present invention.

FIG. 3 is a schematic view showing the separation state of the ball screw and the balls of the present invention.

FIG. 4 is a schematic view showing the power transfer in the combination state of the screw shaft and the ball screw according to the present invention.

FIG. 5 is a schematic view showing the application of the present invention, where the present invention is combined to a silica gel tube of a silica gel gun.

FIG. 6 is a schematic perspective view about another embodiment of the ball screw according to the present invention.

FIG. 7 is an explosive schematic view about another embodiment of the present invention.

FIG. 8 is a schematic view showing the separation state of the screw shaft and the balls according to the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

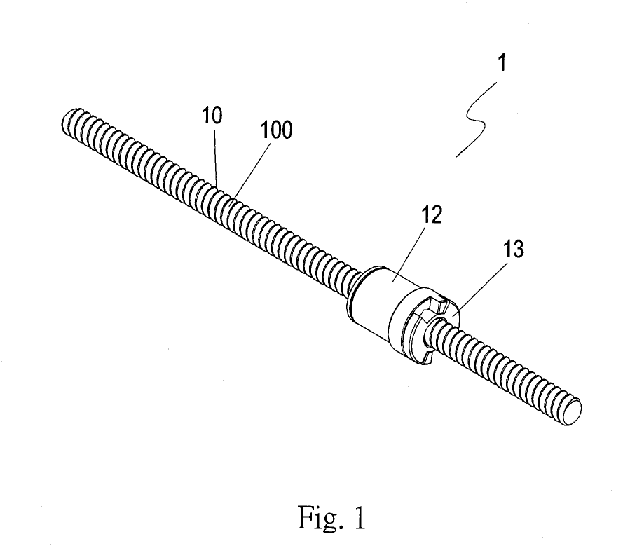

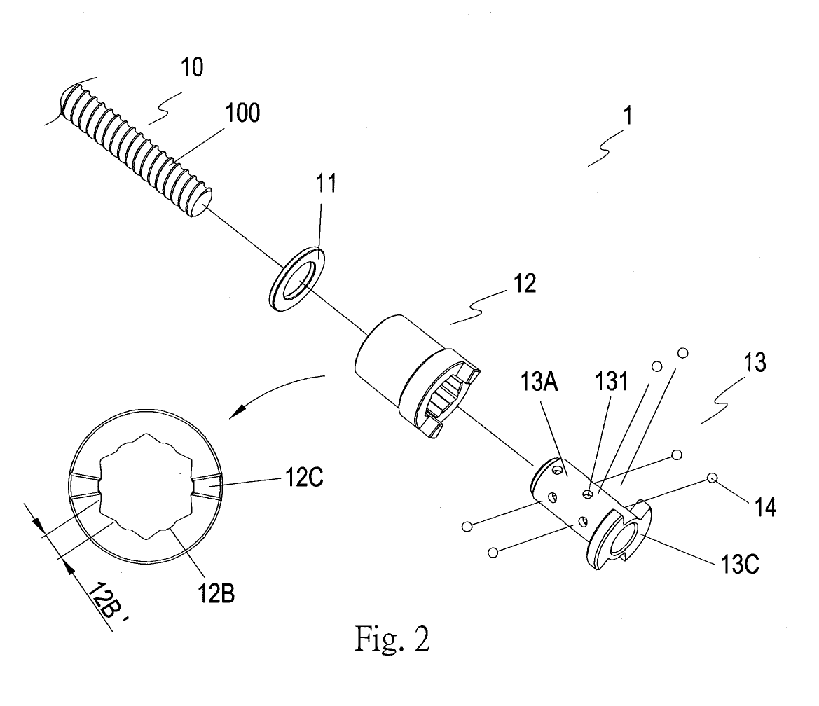

Referring to FIGS. 1 and 2, the separable ball screw 1 of the present invention is illustrated. The present invention has the following elements.

A screw shaft 10 has a helical groove 100 around a shaft body of the screw shaft 10. A transfer ring 13, a plurality of balls 14 and a separable nut 12 are sequentially engaged around the screw shaft 10. One end of the transfer ring 13 is retained with a retaining ring 11 for sealing and limiting the transfer ring 13. The balls 14 are densely distributed upon holes 131 in the annular surface 13A of the transfer ring 13. The balls 14 are moveable longitudinally in the hole 131 and is contactable with the inner annular surface 12B of the separable nut 12. The ball 14 is embedded in the hole 131, while a part of the ball 14 is helical groove 100 of the screw shaft 10.

The transfer ring 13 is hollowed. The plurality of holes 131 are arranged in the annular surface 13A. Each hole 131 is received with a ball 14. The arrangement of the holes 131 are corresponding to the helical groove 100 of the screw shaft 10.

A separable nut 12 has a hollow central portion. An inner annular surface 12B of the separable nut 12 has a plurality of axial grooves 12B′. Each axial groove 12B′ is recessed into the inner annular surface 12B. The inner annular surface 12B is suitable for receiving the annular surface 13A of the transfer ring 13. The ball 14 is embedded in the holes 131 in the annular surface 13A of the transfer ring 13, while two opposite parts of the ball 14 are located between the inner annular surface 12B of the separable nut 12 and the helical groove 100. One end of the separable nut 12 is extended with an annular rib 12C. In assembly, the axial groove 12B resists against an annular stop 13C of the transfer ring 13. By the respective position of the axial groove 12B′ to the annular stop 13C, the respective portion of an axial groove 12B′ in the inner annular surface 12B of the separable nut 12 and the balls 14 are controllable.

When the ball 14 and the axial groove 12B′ are collinear, the ball 14 is movable outwards to contact with the axial groove 12B′ so that the ball 14 separates from the helical groove 100 of the screw shaft 10. At this moment, the transfer ring 13 is parallel to the screw shaft 10. When the when the ball 14 and the inner annular surface 12B of the separable nut 12 are collinear, the ball 14 is limited in the holes 131 of the transfer ring 13 so that the ball 14 is embedded into the helical groove 100 of the screw shaft 10. At this situation, the transfer ring 13 is only rotatable with respect to the screw shaft 10.

In detail, by the annular rib 12C of separable nut 12 to resist against the annular stop 13C of the transfer ring 13, the rolling operation between the screw shaft 10 and the balls 14 can be transferred into the sliding displacement.

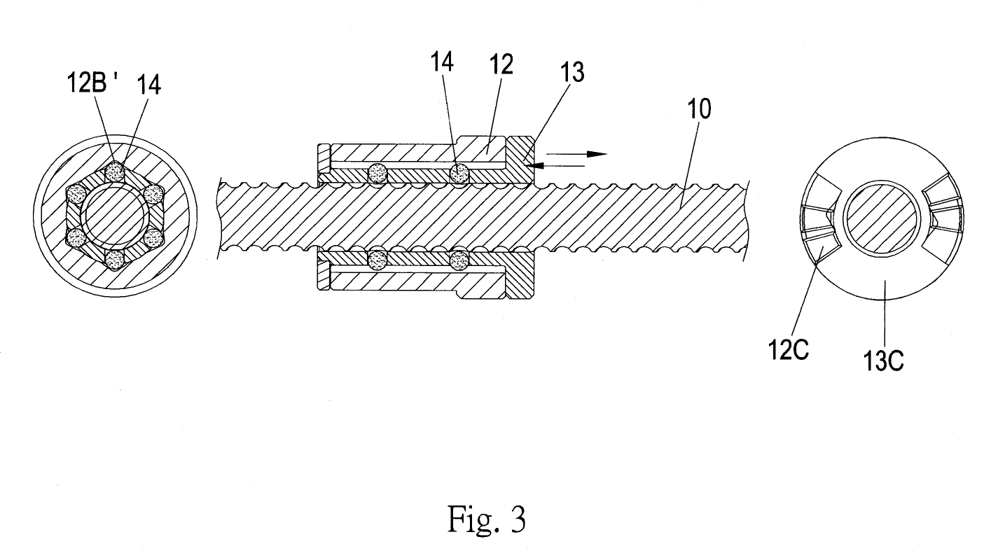

Referring to FIG. 3, when the annular rib 12C of the separable nut 12 rotates counterclockwise and is in contact to the annular stop 13C at one end of the transfer ring 13, through the connection of the annular rib 12C and the annular stop 13C, the balls 14 are at the axial groove 12B′ in the inner annular surface 12B of the separable nut 12, the balls 14 do not separate from the helical groove 100. When the screw shaft 10 rotates counterclockwise (clockwise), the dynamic force is not transferred to the transfer ring 13 through the balls 14. Thus, the transfer ring 13 and the separable nut 12 are not rotated with respect to the screw shaft 10, while it moves along the X axis. The screw shaft 10 is slidable along the transfer ring 13.

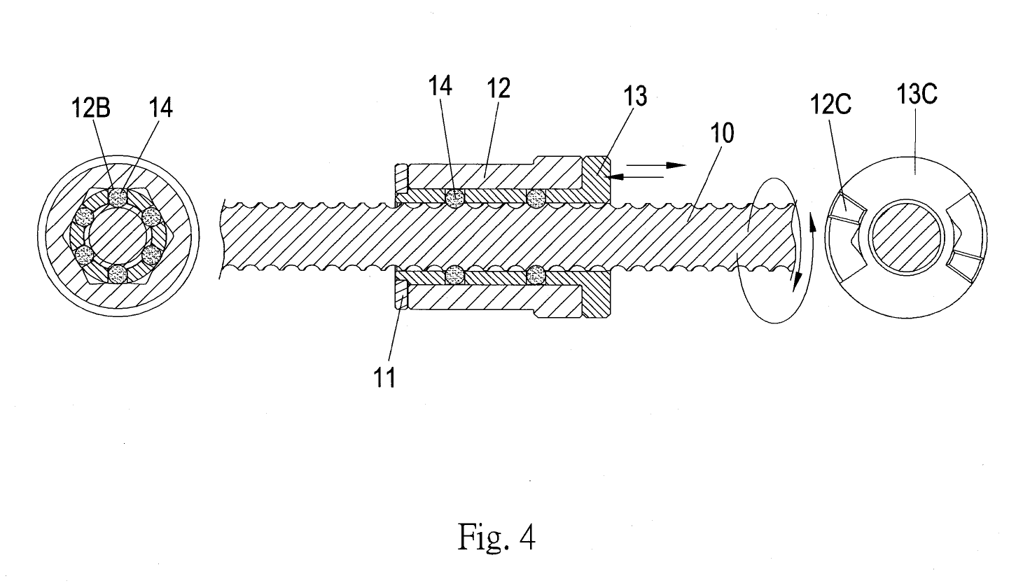

Referring to FIG. 4, when the annular rib 12C extended from the screw shaft 10 rotates clockwise to contact with the annular stop 13C extended from the transfer ring 13, by the connection of the annular rib 12C and the annular stop 13C, the balls 14 are located in the inner annular surface 12B of the separable nut 12. The balls 14 are rollable with friction along the helical groove 100 of the screw shaft 10. When the screw shaft 10 rotates counterclockwise (or clockwise), the balls 14 in the helical groove 100 of the screw shaft 10 will cause the transfer ring 13 and the separable nut 12 to move along the positive (or negative) X axis through the holes 131 of the transfer ring 13. At this situation, the screw shaft 10 is rollable in contact with the balls 14 for transferring dynamic power. This is so called power transfer of ball screw.

By above mentioned mechanism between the screw shaft 10 and transfer ring 13 or the separable nut 12, the movement between the screw shaft 10 and the transfer ring 13 and separable nut 12 may be formed as helical or linear movement from the contact ways of the screw shaft 10 with the ball 14. The present invention is suitable for the driving operations of various ball screws. Furthermore, by using the traveling control of quick detaching from linear operation, the separation time and speed of the screw are controllable effectively so as to improve the prior art defects about the non-real time separation between the screw shaft moving parts and the screw shaft.

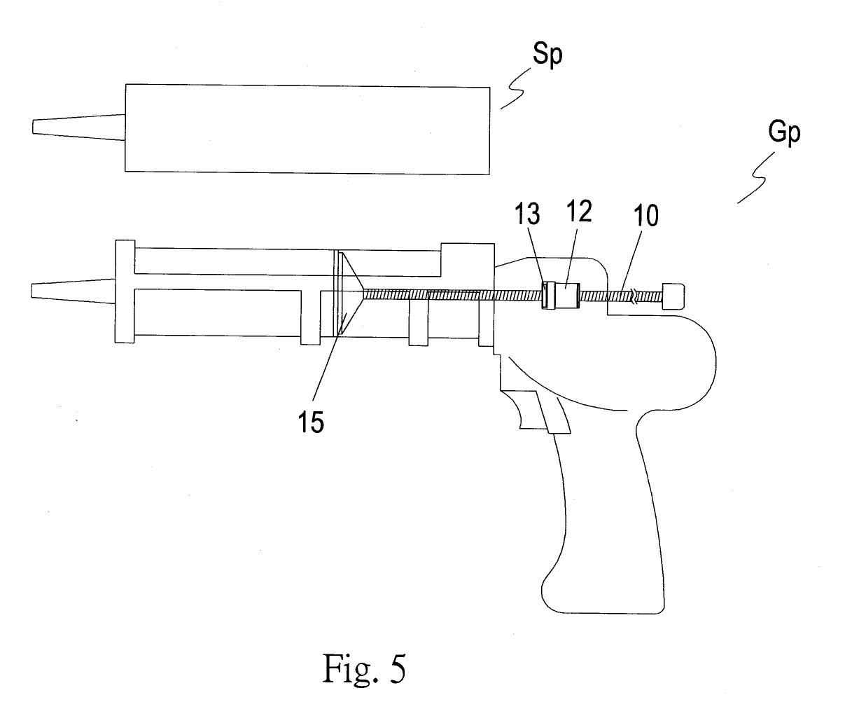

Referring to FIG. 5, it is illustrated that the ball screw 1 of the present invention is applied to a silica gel gun Gp. The separable ball screw 1 of the present invention is inserted into a tube of a silica gel tube Sp. By a driving device to control the screw shaft 10 as a push element, in using the silica gel gun Gp, according to the traveling speed for extruding the silica gel, when the silica gel in the silica gel tube Sp exhausts, the plunger at a force applied end can be returned to an original position rapidly so that the user can update the silica gel tube Sp rapidly and conveniently with a small force. In that, a force applied end at one end of the screw shaft 10 is combined with the transfer ring 13 and the separable nut 12. This is ball screw 1 power transfer state. The transfer ring 13 is limited in a retained position to rotate. The screw shaft 10 has a plane matched to the body of the silica gel gun Gp for confining the screw shaft 10 to move along the X axis. When the transfer ring 13 drives the screw shaft 10 to move linearly, by the plunger 15 to extrude the silica gel in the silica gel tube. It is outputted from another end of the silica gel tube Sp until the silica gel in the silica gel tube Sp is exhausted. When it is desired to update a new silica gel tube Sp, by controlling the relative position of the transfer ring 13 and the separable nut 12 to cause the balls 14 to separate from the screw shaft 10, then the screw shaft 10 can separate from the silica gel tube Sp rapidly. Namely, the plunger 15 will separate from the silica gel tube Sp rapidly.

From about discussion, it is known that by the relative rotation and movement between the transfer ring 13 and the separable nut 12, the operation of rotation and linear movement can be switched rapidly. In fact, other than rotation, parallel movement and helical movement as described therebelow is allowable in the present invention.

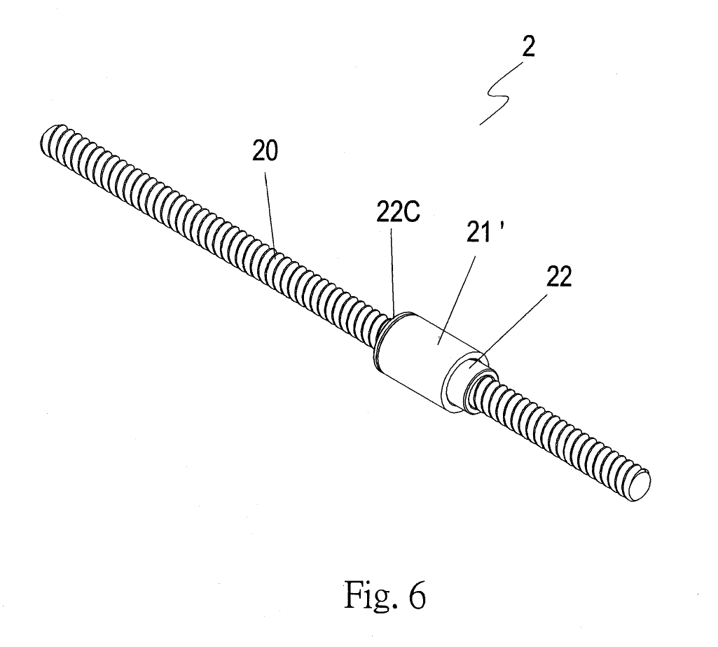

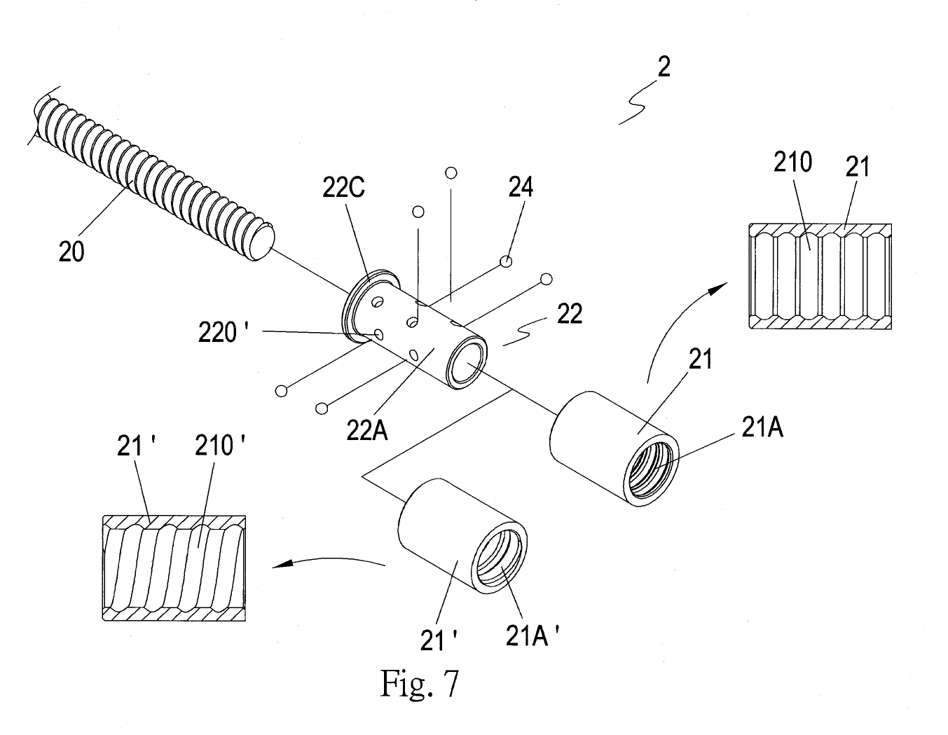

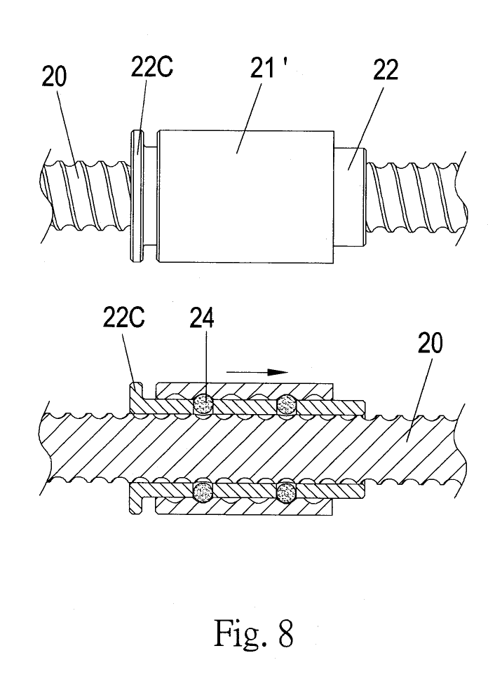

Referring to FIGS. 6 to 8, another embodiment of the present invention is illustrated. The transfer ring 22 of the separable nut 21 linearly displaces with respect to the separable nut 21. An inner annular surface 21A of the separable nut 21 is formed with the annular groove 210 for controlling the position of the balls 24 so as to engage the balls 24 and the screw shaft 20. Another, the inner annular surface 21A′ of the separable nut 21′ can be formed as helical groove 210′ so as to control the movement between the transfer ring 22 and the separable nut 21 as parallel movement or rotation movement. The helical groove 210′ serves to control the position of the balls 24 so as to control the engagement of the balls 24 and the screw shaft 20.

As a whole, by the various designs of holes 220′ in the annular surface 22A of the transfer ring 22 and the radius of curvatures of the helical groove 210′ in the inner annular surface 21A of the separable nut 21 and the distribution and numbers of the balls 24, in helical movement, the screw shaft can suffer from a heavy load or it can be converted into linear movement easily. Furthermore, the annular stop 22C extending from one end of the transfer ring 22 has a gap from one end of the separable nut 21. The gap causes that the separable nut 21 and the transfer ring 22 move linearly and axially. Furthermore, the positions of the balls 24 are limited by the operations of the annular groove 210 or the helical groove 210′ of the separable nut 21 so as to control the initial positions for rotation operation or linear operation between the screw shaft 20 and the transfer ring 22.

Advantages of the present invention will be described herein. Firstly, the present invention provides the helical operation and linear operation to the movement between the screw shaft and the transfer ring 22 by controlling the positions of the balls. The present invention has a firm and concrete structure. Further, the speed can be controlled easily and vividly.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A separable ball screw, comprising:
a screw shaft having a helical groove; a transfer ring, a plurality of balls and a separable nut being sequentially engaged to the screw shaft; the balls being distributed in the holes in the annular surface of the transfer ring;
the transfer ring being hollowed, the retaining ring enclosing around the screw shaft; the plurality of holes being formed in the annular surface; the balls being received in the holes;
the balls being received in the holes of the transfer ring as power transfer medium between the transfer ring and the screw shaft; and
a separable nut having a hollow center; the separable nut enclosing around the transfer ring; an inner annular surface of the separable nut having at least one grooves; the inner annular surface and the groove serving for limiting positions of the balls; when the balls in the grooves, the screw shaft being not engaged to the transfer ring; the screw shaft moves linearly, when the balls being limited by the inner annular surface, it is driven as the ball screw.

2. The separable ball screw, wherein a plurality of grooves are axially formed in the inner annular surface of the separable nut.

3. The separable ball screw as claimed in claim 2, wherein the separable nut and the transfer ring are rotated along an axial direction.

4. The separable ball screw as claimed in claim 3, wherein an annular rib extends from one end of the separable nut; and an annular stop extends from one end of the transfer ring; with the axial grooves in the separable nut, the positions of the balls are limited so as to determine an initial position as the operation between the screw shaft and the transfer ring is converted into linear operation from rotation operation.

5. The separable ball screw as claimed in claim 1, wherein the separable nut and the transfer ring are rectilinear motion along an axial direction.

6. The separable ball screw as claimed in claim 1, wherein the separable nut and the transfer ring are rotation and rectilinear motion along an axial direction.

7. The separable ball screw as claimed in claim 5, wherein the annular stop extending from one end of the transfer ring has a gap from one end of the separable nut; the gap causes that the separable nut and the transfer ring move linearly, the positions of the balls are limited by the operations of the inner annular surface or the groove of the separable nut so as to control the initial positions for rotation operation as a ball screw operation or linear operation between the screw shaft and the transfer ring as a sliding track.

8. The separable ball screw as claimed in claim 6, wherein the annular stop extending from one end of the transfer ring has a gap from one end of the separable nut; the gap causes that the separable nut and the transfer ring move linearly and axially, the positions of the balls are limited by the operations of the inner annular surface or the groove of the separable nut so as to control the initial positions for rotation operation as a ball screw operation or linear operation between the screw shaft and the transfer ring as a sliding track.

9. The separable ball screw as claimed in claim 5, wherein there are plurality of grooves in the separable nut, and each groove in the separable nut is a round groove.

10. The separable ball screw as claimed in claim 6, wherein there are plurality of grooves in the separable nut, and each groove in the separable nut is a round groove.

11. The separable ball screw as claimed in claim 5, wherein there are plurality of grooves in the separable nut, and each groove in the separable nut is a helical groove and is a piece like groove.

12. The separable ball screw as claimed in claim 6, wherein there are plurality of grooves in the separable nut, and each groove in the separable nut is a helical groove and is a piece like groove.

13. The separable ball screw as claimed in claim 1, wherein the ball screw inserts into a silica gel tube of a silica gel gun; the transfer ring is limited to rotate at a fixed position; the screw shaft has a plane for matching with the silica gel gun for limiting the screw shaft to move along an X axis; when the transfer ring drives the screw shaft to move linearly, a plunger will extrude silica gel in the silica gel tube; when a relative position between the transfer ring and the silica gel tube is controlled, the balls will separate from the screw shaft so that the plunger will separate from the silica gel tube for updating a new silica gel tube.
